(19) United States
(12) Patent Application Publication
(10) Pub. No.: US 2026/0061650 A1
(43) Pub. Date: Mar. 5, 2026

(54) COCONUT CUTTING DEVICE

(71) Applicants: David Smith, Jupitor, FL (US); Wang Yaping, Ningbo (CN)

(72) Inventors: David Smith, Jupitor, FL (US); Wang Yaping, Ningbo (CN)

(21) Appl. No.: 19/317,751

(22) Filed: Sep. 3, 2025

Related U.S. Application Data
(60) Provisional application No. 63/689,934, filed on Sep. 3, 2024.

(51) Int. Cl. B26D 1/08; A23N 5/03; B26D 3/30; B26D 7/01

(52) U.S. Cl. CPC B26D 1/08; A23N 5/03; B26D 3/30; B26D 7/01; B26D 2210/02

(57) ABSTRACT

A coconut cutting device includes a knife having an elongated, straight blade, a handle coupled to a first end of the blade, a base pivotally connected to the second end of the blade via a hinge, allowing the blade to rotate about the hinge, the base configured to stabilize the coconut during a cutting operation, a slot formed within the base, the slot configured to accommodate the blade when the blade is fully rotated towards the base, a downward facing spike coupled to the handle, and positioned to engage the coconut, and, a platform coupled to the base and positioned beneath the spike, the platform configured to stabilize the coconut during a piercing operation.

### CROSS-REFERENCE TO RELATED APPLICATIONS

This patent application claims benefit of provisional patent application No. 63/689,934 filed Sept. 3, 2024, and titled “coconut cutting device”. The subject matter of provisional patent application No. 63/689,934 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of tools and devices for food preparation and, more specifically, relates to the field of mechanical or manually operated devices that facilitate opening of coconuts.

### BACKGROUND

Coconuts are widely consumed for their water and meat, which are valued for their nutritional benefits and unique flavor. However, accessing the edible parts of a coconut is often a challenging task due to the hardness of its inner coconut nut and the fibrous husk that surrounds it. Traditionally, people have relied on various manual tools, such as machetes or knives, to cut and open coconuts. These methods require significant skill and strength, posing a risk of injury to the user. Furthermore, traditional methods are time-consuming and often result in uneven cuts or damage to the coconut, leading to wastage of its contents.

The devices available today typically involve either manual or mechanical operations designed to remove the husk and pierce the nut. However, many of these devices are either cumbersome to use, do not adequately secure the coconut during the cutting process, or fail to provide a clean, precise cut, leading to inefficiency and safety concerns. Moreover, existing devices often lack versatility, being designed either for husk removal or for piercing the coconut to access its water, but not both. Further, penetrating the coconut nut breaks the integrity of the coconut nut, which makes the process more difficult. As a result, users may need to employ multiple tools or devices to fully open and access the contents of a coconut, further complicating the process.

Therefore, a need exists to overcome the problems with the prior art as discussed above, and particularly for a more effective, efficient, and safe way of cutting or opening a coconut.

### SUMMARY

A coconut cutting device is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a coconut cutting device is provided that solves the above-described problems. The coconut cutting device includes a knife having an elongated, straight blade, a handle coupled to a first end of the blade, a base pivotally connected to the second end of the blade via a hinge, allowing the blade to rotate about the hinge, the base configured to stabilize the coconut during a cutting operation, a slot formed within the base, the slot configured to accommodate the blade when the blade is fully rotated towards the base, a downward facing spike coupled to the handle, and positioned to engage the coconut, and, a platform coupled to the base and positioned beneath the spike, the platform configured to stabilize the coconut during a piercing operation.

### BRIEF DESCRIPTION OF THE DRAWINGS

The accompanying drawings, which are incorporated in and constitute a part of this disclosure, illustrate various example embodiments. In the drawings:

FIG. 1 is a photograph of a side perspective view of the coconut cutting device in an open orientation, according to an embodiment.

FIG. 2 is a photograph of a top perspective view of the coconut cutting device in an open orientation, according to an embodiment.

FIG. 3 is a photograph of a rear perspective view of the coconut cutting device in an open orientation, according to an embodiment.

FIG. 4 is a photograph of a top perspective view of the coconut cutting device in a closed orientation, according to an embodiment.

FIG. 5 is a photograph of a top perspective view of the coconut cutting device in a closed orientation, according to an embodiment.

FIG. 6 is a photograph of a side perspective view of the coconut cutting device during use, according to an embodiment.

FIG. 7 is a photograph of a front perspective view of the coconut cutting device during use, according to an embodiment.

FIG. 8 is a photograph of a side perspective view of the coconut cutting device during use, according to an embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by addressing issues associated with traditional coconut opening tools and methods. One of the primary advancements is the integration of both husk removal and shell piercing into a single, easy-to-use device. Traditional methods often require multiple tools, such as machetes and hammers, which not only demand considerable skill and strength but also pose a high risk of injury. The claimed subject matter simplifies the process by combining these functions, allowing users to safely and efficiently cut and remove the coconut husk, and then pierce the shell to access the water, all without the need for additional tools. The claimed subject matter's design, which includes a stable base, a hinged blade, and a secure spike, ensures that the coconut remains firmly in place during both operations, reducing the risk of slippage and accidents, which is a common problem with prior art.

Additionally, the claimed subject matter solves problems related to the lack of precision and efficiency in existing tools. Many traditional devices and methods result in uneven cuts, leading to wastage of the coconut water and meat. The claimed subject matter, with its straight, elongated blade and precision-aligned slot in the base, ensures a clean and complete cut every time. The stable platform and ergonomic handle further enhance control, allowing users to apply the necessary force without straining, thus improving both the safety and ease of the coconut opening process. By streamlining the operation and offering a more controlled and safe cutting mechanism, the claimed subject matter provides a more reliable and user-friendly solution, making coconut opening accessible to a wider range of users, including those who may not have the physical strength or expertise required for traditional methods.

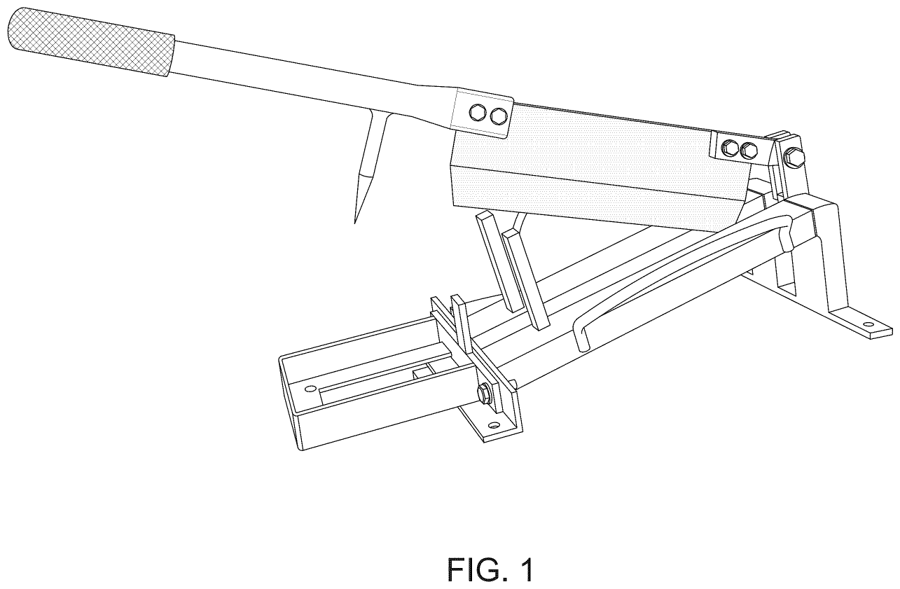

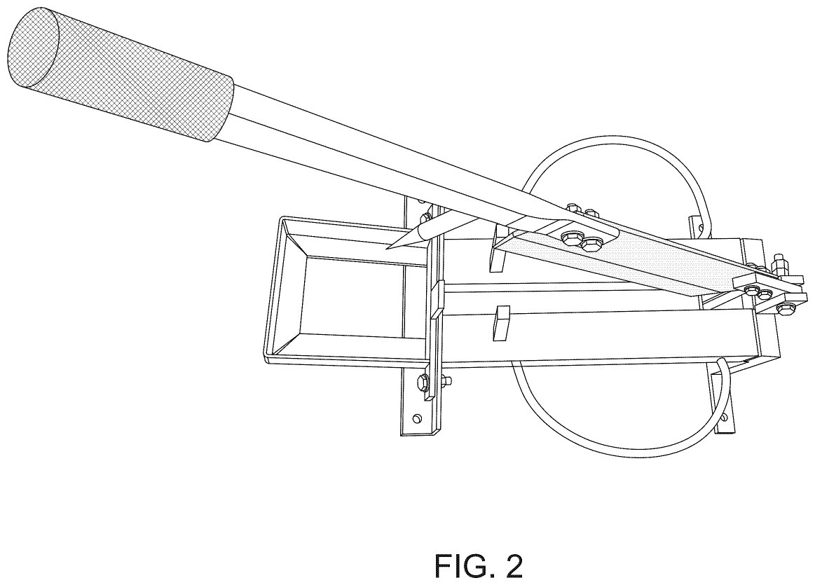

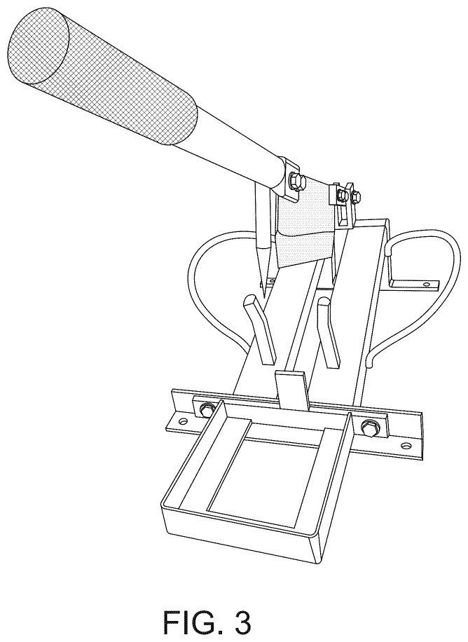

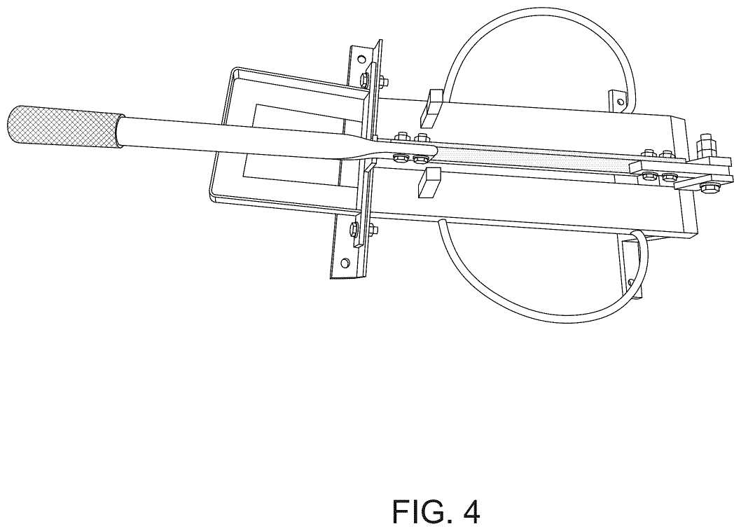

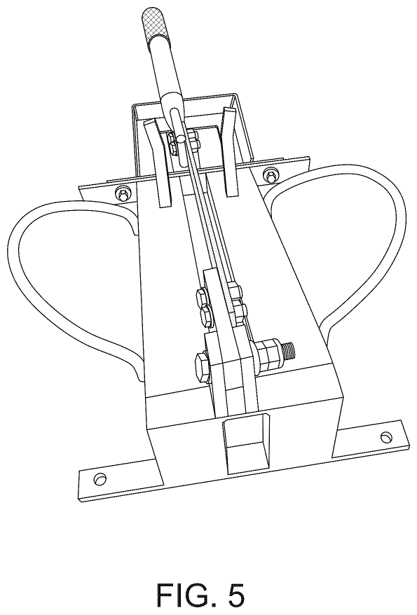

The accompanying drawings, which are incorporated in and constitute a part of this disclosure, illustrate various example embodiments. The claimed coconut cutting device 100 will now be described with respect to FIGS. 1 through 8, each of which demonstrates different views and operational states of the device. FIG. 1 shows a side perspective view of the coconut cutting device 100 in an open orientation, where the knife or blade 102 is raised above the base 108. FIG. 2 provides a top perspective view of the device 100 in the same open orientation, allowing a clearer view of the alignment between the knife 102 and the slot 112 in the base 108. FIG. 3 presents a rear perspective view of the device 100, further highlighting the connection between the knife 102 and the handle 104, as well as the positioning of the spike 116. FIGS. 4 and 5 show the coconut cutting device 100 in a closed orientation, where the knife 102 is fully rotated into the slot 112 in the base 108, with FIG. 4 offering a side perspective and FIG. 5 a top perspective.

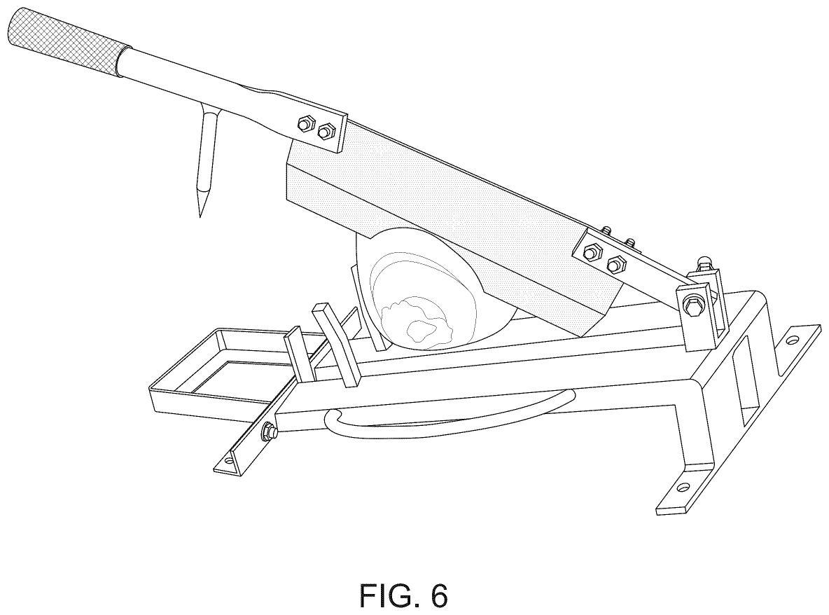

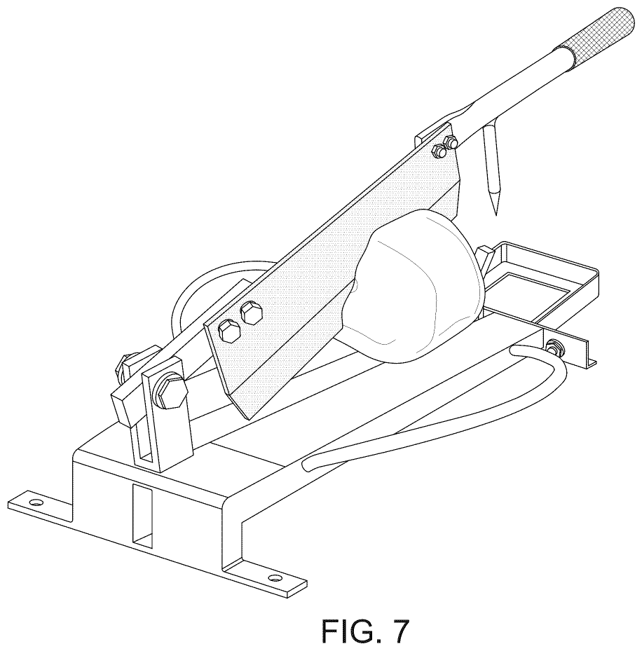

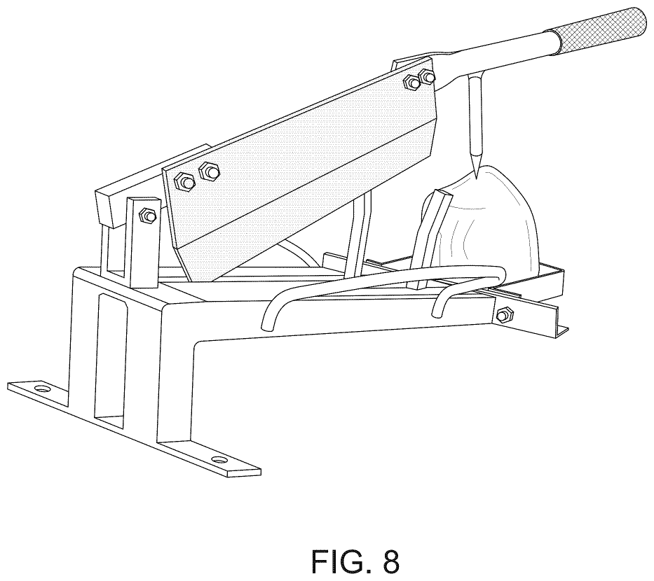

FIGS. 6 through 8 demonstrate the device 100 in use, with a coconut positioned on the base 108, undergoing the cutting and piercing operations. FIG. 6 shows the husk of the coconut being removed by the blade 102 as the coconut sits on the parallel bars 115 of the base 108. FIG. 7 shows the central core of the coconut being opened by the blade 102 as the coconut sits on the parallel bars 115 of the base 108. FIG. 8 shows the central core of the coconut being pierced by the spike 116 as the coconut sits on the platform 118.

The coconut cutting device 100 comprises several key components designed to facilitate the efficient and safe removal of the coconut husk and the subsequent piercing of the coconut to access its coconut water. The knife 102, equipped with an elongated, straight blade, is the primary cutting element of the device 100. The blade is designed to penetrate the tough husk and outer shell of the coconut. The knife 102 is attached to a handle 104 at its first end via one or more fasteners, such as nuts and bolts. The handle is ergonomically designed for ease of use. The handle 104 may be covered with a rubber sheath 106 to provide a non-slip grip, enhancing user safety during the cutting process.

The knife 102 is pivotally connected to a base 108 via a hinge 110 located at the second end of the blade. The knife 102 may be pivotally connected to the hinge 110 via an intermediate element 109, which may be an elongated element that attaches to the knife on one end (using fasteners such as nuts and bolts) and the hinge on the other end. This hinge 110 allows the knife 102 to rotate about its axis, moving between an open position (see FIG. 1), where the blade is raised, and a closed position (see FIG. 4), where the blade is lowered into the slot 112 formed within the base 108. The base 108 serves as a stabilizing platform for the coconut during the cutting operation. The slot 112 is precisely aligned to accommodate the knife 102 when it is fully rotated, ensuring that the blade can pass through the coconut entirely, resulting in a clean cut.

To further stabilize the coconut during cutting, the base 108 includes two parallel bars 115 between which the slot 112 is situated. These bars 115 provide structural support and help guide the knife 102 into the slot 112. Further, the bars have a slight downward angle as they extend from the distal end to the proximal end of the device 100 towards the two vertical posts 130. The angle enables the coconut to falls toward the user and against the posts during the cutting operation, using gravity to keep the coconut in the proper place during cutting. This ensures the coconut or coconut nut is in the proper place (under the knife) during cutting.

The base 108 is also equipped with wings 120 and 122 on its right and left sides, respectively, which help to secure the coconut during the cutting process by providing lateral support.

Additionally, the base 108 is supported by a pair of front vertical legs 119, and front horizontal feet 134, ensuring the device 100 remains stable on the working surface. The front vertical legs attach to the front horizontal feet at the distal end of the device 100. The bars 115 attach to the rear horizontal feet 136 at the proximal end of the device 100. The rectangular element 132 may be coupled to the rear horizontal feet 136 at the proximal end of the device 100 such that the rectangular element 132 is nearest the user during use of the device 100. The rectangular element 132 may be coupled to the rear horizontal feet 136 via fasteners such as nuts and bolts.

Each of the wings 120 is formed as a semi-circle that extends around the area under the knife 102. This is because during cutting of the coconut, the coconut can shift or move. The wings 120 are placed on either side of the area under the knife 102 such that they catch the coconut if it shifts during cutting. In the absence of said wings, the coconut would fall to the ground if it shifted laterally during cutting.

The device 100 also features a downward-facing spike 116, which is coupled to the handle 104. The downward-facing spike 116 is located on the handle 104 between the rubber sheath grip 106 and the knife 102. The spike 116 is positioned above a platform 118 that is also coupled to the base 108. This platform 118 is designed to engage and hold the coconut in place during the piercing operation, preventing it from slipping. The platform 118 is positioned directly beneath the spike 116 and is designed to support the coconut during the piercing process. The platform 118 may include a rectangular element 132 with raised edges, providing additional stability to the coconut during this operation. The platform 118 also includes a square or rectangular shaped orifice or void in its center that allows coconut juice to flow therethrough during the piercing process.

Two vertical bars 130 extend upwards from the parallel bars 115, further assisting in stabilizing the coconut during the cutting and piercing processes. Further, the device 100 is designed with a slight downward angle relative to the two vertical posts 130. This allows the coconut to fall against the posts during the cutting operation, using gravity to keep the coconut in the proper place during cutting. This ensures the the coconut or coconut nut is in the proper place (under the knife) during cutting.

The operation of the coconut cutting device 100 begins with the user placing the coconut on the base 108, positioning it between the wings 120 and 122 for lateral stability. The user then grips the handle 104, raising the knife 102 above the coconut. By applying downward force, the user rotates the knife 102 about the hinge 110, causing the blade to descend and cut through the coconut husk and nut. The blade passes through the coconut and into the slot 112 in the base 108, ensuring a complete and clean cut. This process effectively removes the husk and splits the coconut nut.

After the husk is removed, the user then places the coconut nut on the platform 118, aligning it beneath the spike 116. The user applies downward pressure on the handle 104, driving the spike 116 into the coconut nut. This piercing action creates an opening in the coconut nut, allowing the user to access the water inside. The platform 118, with its rectangular element 132 and raised edges, ensures that the coconut remains stable during this operation, preventing any movement that could hinder the piercing process. On the proximal end of the platform 118 is a vertical bar 133. Said vertical bar acts to keep the coconut in place during piercing. The coconut may shift during piercing. The vertical bar prevents the coconut from moving upwards toward the device 100 during piercing.

Note that FIG. 6 shows the husk being removed, while FIG. 8 shows the coconut nut being placed in the coconut holder or rectangular element 132 and the spike penetrating the coconut nut, allowing one to access the coconut water. Note also that FIG. 7 shows that after the coconut nut has been pierced and the water is removed, then one can place the coconut in the base 108 and line up the blade over the top of the hole in the coconut and then cut the coconut in half, allowing to access the coconut meat. Having the hole in the coconut and the coconut nut breaks the integrity of the coconut and coconut nut, allowing one to cut the coconut in half. Without the hole in the coconut and coconut nut, one would not be able to cut the middle of the coconut or coconut nut. Hence the actions of FIG. 7 would be executed after the actions of FIGS. 6 and 8.

Through the combination of the knife 102 for cutting and the spike 116 for piercing, the coconut cutting device 100 provides a comprehensive solution for safely and efficiently opening coconuts, minimizing the risk of injury, and maximizing the ease of use.

The components of the claimed embodiments may be manufactured from a variety of different materials. The blade 102, being the primary cutting element, may be manufactured from high-grade stainless steel, which is well-known for its excellent corrosion resistance, strength, and ability to maintain a sharp edge over time. The blade may also be manufactured from carbon steel, known for its hardness and superior edge retention. The blade may also be manufactured with a non-stick or anti-corrosive material, such as titanium or ceramic, to further enhance its durability and cutting performance. Further, the blade strikes a balance between sharpness and strength (width) so that it can cut any type of coconut or coconut nut, including tender young coconuts, shaved Thai coconuts, older coconuts, white coconut nuts, mature (brown) coconut nuts.

The handle 104 of the claimed embodiments may be manufactured from metal (such as aluminum or stainless steel) or reinforced plastic, which is resistant to moisture and wear, making it a practical choice for a handle that will be frequently exposed to water during coconut cutting. For added comfort and to ensure a secure grip, the handle might be covered with a rubber sheath, which provides a non-slip surface and reduces the likelihood of accidents during use. The handle may also be manufactured from materials such as wood, which not only add to the aesthetic appeal but also increase the durability of the device. Wood handles might be treated with waterproof sealants to protect against moisture.

The base 108 of the claimed embodiments may be manufactured from a variety of materials depending on the desired balance of strength, weight, and cost. Metals such as aluminum or stainless steel are common choices for the base, offering robustness and resistance to deformation under the force applied during cutting. Alternatively, the base could be made from high-density plastic, with its resistance to corrosion, ease of manufacturing, and lower cost, making it an attractive option for mass production. The base may also incorporate a combination of metal and plastic, using metal for key structural elements and plastic for areas where weight reduction is beneficial. The spike 116 may be manufactured from hardened steel and may be coated with a corrosion-resistant material, such as zinc or a polymer coating.

Finally, the platform 118 may be manufactured from the same materials as the base, such as high-density plastic or metal. The platform might feature additional elements like raised edges or grooves, which could be made from the same material or reinforced with a different, more wear-resistant material to provide better grip and stability.

The coconut cutting device 100 may be painted or coated with a protective finish not only for aesthetic appeal but also to enhance its durability and resistance to environmental factors. Painting the device, particularly the metal components like the blade, base, and spike, can provide an additional layer of protection against rust and corrosion, which is important given the exposure to moisture and organic materials during coconut cutting. The paint or coating used could be a high-quality, food-safe, and non-toxic finish that adheres well to metal and plastic surfaces, ensuring that it does not chip or wear off easily during regular use. Additionally, painting the device 100 can improve its marketability by offering it in various colors, making it more attractive to consumers. The color choice can also serve a functional purpose, such as using bright colors for better visibility or using darker shades to hide stains and maintain a cleaner appearance over time Embodiments may be described above with reference to functions or acts, which comprise methods. The functions/acts noted above may occur out of order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods'functions/acts may be modified in any manner, including by reordering functions/acts and/or inserting or deleting functions/acts, without departing from the spirit of the claimed subject matter.

The coconut cutting device 100 is designed with safety and practicality in mind. When the blade 102 is not in use, it fits securely within the base 108, with the knife blade fully concealed. This ensures that the sharp edge is not exposed, reducing the risk of accidental cuts and making the device safer to handle and store. Additionally, the device 100 is constructed with a focus on durability and strength. Except for the blade 102 and the coconut holder platform 118, the base 108 and all other structural components are welded together as a single piece. This welded construction significantly enhances the overall strength and stability of the device compared to designs that rely on multiple assembled parts. Although this manufacturing process incurs higher costs, it results in a robust device with a substantial feel, conveying a sense of quality and reliability to the user.

Moreover, the device 100 is designed with a slight downward angle relative to the two vertical posts 130. This angle is strategically implemented to maximize the force applied during the cutting operation. By positioning the coconut or coconut nut at this angle, the device leverages gravity and the user's applied force more effectively, ensuring a cleaner, more efficient cut that facilitates the opening of the coconut husk and shell with minimal effort. This thoughtful design consideration enhances the functionality and ease of use, making the device both practical and powerful.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A coconut cutting device, comprising:
a) a knife having an elongated, straight blade;
b) a handle coupled to a first end of the blade;
c) a base pivotally connected to the second end of the blade via a hinge, allowing the blade to rotate about the hinge, the base configured to stabilize a coconut during a cutting operation;
d) a slot formed within the base, the slot configured to accommodate the blade when the blade is fully rotated towards the base;
e) a downward facing spike coupled to the handle, and positioned to engage the coconut; and
f) a platform coupled to the base and positioned beneath the spike, the platform configured to stabilize the coconut during a piercing operation.

2. The coconut cutting device of claim 1, wherein the base further comprises two parallel bars including the slot between the two parallel bars.

3. The coconut cutting device of claim 2, wherein the base further comprises a first end adjacent to the handle and a raised second end on which the hinge is situated.

4. The coconut cutting device of claim 3, wherein the base further comprises a wing at its right side, the wing configured to stabilize the coconut during the cutting operation.

5. The coconut cutting device of claim 4, wherein the base further comprises a wing at its left side, the wing configured to stabilize the coconut during the cutting operation.

6. The coconut cutting device of claim 5, wherein the base further comprises two vertical bars extending upwards from the two parallel bars, the two vertical bars configured to stabilize the coconut during the cutting operation.

7. The coconut cutting device of claim 6, wherein the platform further comprises a rectangular element with raised edges for stabilizing the coconut during the piercing operation.

8. The coconut cutting device of claim 7, wherein the handle further comprises a rubber sheath covering a proximal end of the handle.

9. The coconut cutting device of claim 8, wherein the downward facing spike is coupled to the handle between the rubber sheath and the knife.

10. The coconut cutting device of claim 9, further comprising a vertical bar coupled to a distal end of the platform to prevent the coconut from moving forward.

11. A coconut cutting device, comprising:
a) a knife having an elongated, straight blade;
b) a handle coupled to a first end of the blade;
c) two parallel bars configured to stabilize a coconut during a cutting operation;
d) a hinge located on a distal end of the two parallel bars, the hinge coupled to a second end of the blade and allowing the blade to rotate about the hinge;
e) a slot formed between the two parallel bars, the slot configured to accommodate the blade when the blade is fully rotated towards the two parallel bars;
f) a downward facing spike coupled to the handle, and positioned to engage the coconut; and
g) a platform coupled to a proximal end of the two parallel bars and positioned beneath the spike, the platform configured to stabilize the coconut during a piercing operation.

12. The coconut cutting device of claim 11, wherein the distal end of the two parallel bars is higher than the proximal end of the two parallel bars.

13. The coconut cutting device of claim 12, further comprising legs located underneath the distal end of the two parallel bars.

14. The coconut cutting device of claim 13, further comprising a wing located at a left side of the two parallel bars, the wing configured to stabilize the coconut during the cutting operation.

15. The coconut cutting device of claim 14, further comprising a wing located at a right side of the two parallel bars, the wing configured to stabilize the coconut during the cutting operation.

16. The coconut cutting device of claim 15, further comprising two vertical bars extending upwards from the two parallel bars, the two vertical bars configured to stabilize the coconut during the cutting operation.

17. The coconut cutting device of claim 16, wherein the platform further comprises a rectangular element with raised edges for stabilizing the coconut during the piercing operation.

18. The coconut cutting device of claim 17, wherein the handle further comprises a rubber sheath covering a proximal end of the handle.

19. The coconut cutting device of claim 18, wherein the downward facing spike is coupled to the handle between the rubber sheath and the knife.

20. The coconut cutting device of claim 19, further comprising a vertical bar coupled to a distal end of the platform to prevent the coconut from moving forward.
